(19) United States
(12) Patent Application Publication
(10) Pub. No.: US 2003/0090694 A1
(43) Pub. Date: May 15, 2003

(54) Just-in-time printer discovery and driver installation system and method

(76) Inventors: Kelli H. Kennedy, Boise, ID (US); Darrel D. Cherry, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/054,156

(22) Filed: Nov. 13, 2001

(51) Int. Cl. B41B 1/00; G06F 15/00

(52) U.S. Cl. 358/1.13; 358/1.15

(57) ABSTRACT

A method, logic and computer system for determining information regarding at least one printer available to receive a print job from a client computer. A query is transmitted from the client computer to a server via a network for an identification of the at least one available printer. An identification of the at least one available printer is received from the server. A file is downloaded from the server, the file being used to support printing to a selected one of the at least one available printer.

### TECHNICAL FIELD

The present invention generally relates to computer system utilities and, more particularly, to a system and method for discovering printers and installing printer driver software.

### BACKGROUND OF THE INVENTION

When printing data from an application (or computer program) being executed by a computing device to a printer, the computing device uses a printer driver to convert the application specific data into a printer specific format. Accordingly, to print to a selected printer, the computing device must have a driver intended for use with the selected printer. If the computing device does not have the appropriate printer driver, the user of the computing device must seek out the driver and properly install the driver on the computing device. Seeking out the driver can include, for example, finding the driver on the world-wide-web (or the Internet) and downloading the driver; finding the driver on a computer readable medium (such as a CD-ROM) and copying the driver to the computing device; and the like. Installing the driver can include, for example, running a setup routine, “adding” the printer to a “printers folder” (such as in a Windows operating system) or a “chooser menu” (such as in a Macintosh operating system), or similar operation.

Often, printers are shared among multiple users over a network. Should the user of a computer that is new to the network wish to print a document with one of the networked printers, an appropriate driver must be found and installed on the computer. The same is true for existing computers when a new printer is added to the network. This problem is particularly troublesome for those who do not often use the network, such a visitor to a facility using a portable computer. It is believed that many routine users of a particular printer or printers would not mind taking the time to find and install a printer driver. However, for users that do not regularly print to the desired printer, finding, installing and perhaps removing (when finished printing) an appropriate printer driver for use with a selected printer could be tedious. In addition, these users may not know what types of printers may be available to them, the physical location of those printers and/or which specific printer driver to obtain.

Therefore, there exists a need in the art for a way to discover and print to printers available to a computer user.

### SUMMARY OF THE INVENTION

According to one aspect of the invention, the invention is a method of determining information regarding at least one printer available to receive a print job from a client computer. The method includes transmitting a query from the client computer to a server via a network for an identification of the at least one available printer; receiving an identification of the at least one available printer from the server; and downloading a file from the server used to support printing to a selected one of the at least one available printer.

According to another aspect of the invention, the invention is a client computer adapted for communication with a network, the network having a server and at least one printer, the client computer having a utility for determining information regarding the at least one printer. The client computer includes means for transmitting a query to the server via a network for an identification of the at least one available printer; means for receiving an identification of the at least one available printer from the server; and means for downloading a file from the server used to support printing to a selected one of the at least one available printer.

According to yet another aspect of the invention, the invention is a program embodied in computer readable medium to determine information regarding at least one printer available to receive a print job from a client computer. The program includes code that transmits a query from the client computer to a server via a network for an identification of the at least one available printer; code that receives an identification of the at least one available printer from the server; and code that downloads a file from the server used to support printing to a selected one of the at least one available printer.

According to still another aspect of the invention, the invention is a program embodied in computer readable medium for execution by a server to enable a client computer to determine information regarding at least one printer available to receive a print job from the client computer. The program includes code that receives a query from the client computer via a network for an identification of the at least one available printer; code that transmits an identification of the at least one available printer to the client computer; and code that transmits a file to the client computer, the file used to support printing to a selected one of the at least one available printer.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a computer system according to the present invention;

FIG. 2 is a block diagram illustrating events occurring within the computer system of FIG. 1 and data transferred within the computer system of FIG. 1 during a printer discovery operation;

FIG. 3 is a flow chart of the printer discovery operation of FIG. 2;

FIG. 4 is a graphical user interface (GUI) generated by the computer system of FIG. 1 after a user has selected a print command; and

FIG. 5 is a GUI generated by the computer system of FIG. 1 for displaying a list of available printers.

### DETAILED DESCRIPTION OF THE INVENTION

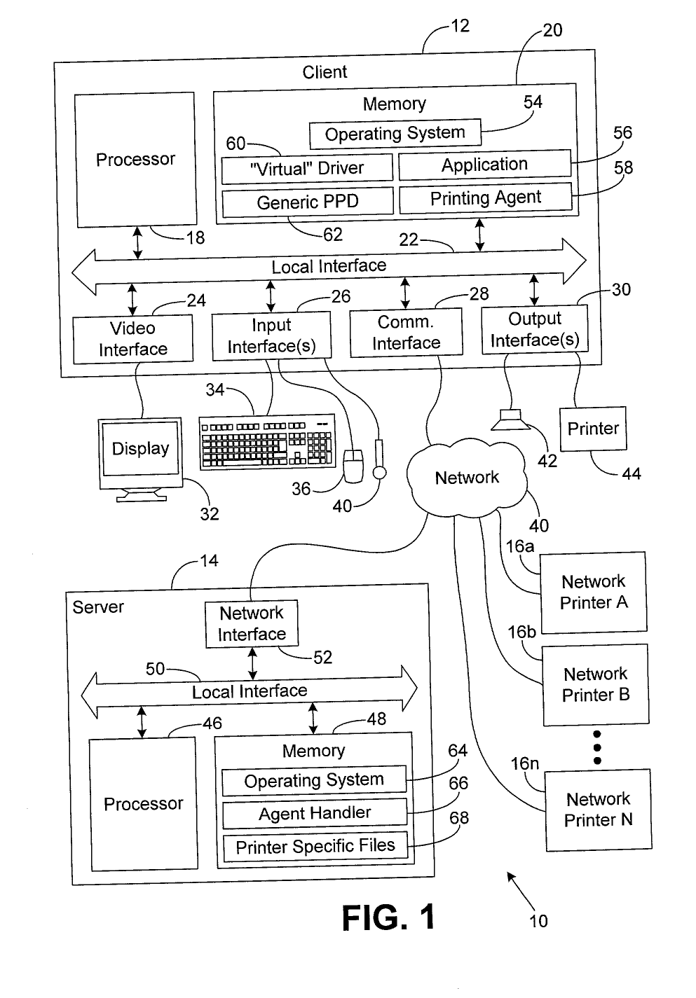

Referring initially to FIG. 1, a computer system 10 is illustrated. The computer system 10 includes at least one client computer 12, a server 14 and at least one network printer 16. As illustrated in FIG. 1, there are a plurality of network printers identified generically as printers 16a-16n. As used herein, the terms “computer,” “computing device,” and the like are used in their broadest sense, and can include, for example, devices such as desktop computers, workstations, portable computers (often referred to as notebook or laptop computers), personal digital assistants (PDAs) and network servers. As used herein the term “printer” is used in its broadest sense, and can include, for example, ink jet printers, laser printers, thermal printers, copy machines, fax machines, plotters, imagesetters, and other devices used to place a desired pattern on a print medium.

The client computer 12 has a processor 18 for executing instructions, usually in the form of computer code, to carry out a specified logic routine. The illustrated processor 18 can represent multiple processors. The processor 18 can be electrical or optical in nature.

The client computer 12 also has a memory 20 for storing data, software, logic routine instructions, computer programs, files, operating system instructions, and the like. The memory 20 can comprise several devices and includes, for example, volatile and non-volatile memory components. Volatile memory components typically do not retain data values upon a loss of power. Non-volatile memory components retain data upon a loss of power. Thus, the memory 20 can include, for example, random access memory (RAM), read-only memory (ROM), hard disks, floppy disks, compact disks (including, but not limited to, CD-ROM, DVD-ROM and CD-RW), tapes, and/or other memory components, plus associated drives and players for these memory types. In addition, the RAM may comprise, for example, static random access memory (SRAM), dynamic random access memory (DRAM), magnetic random access memory (MRAM), and/or other such devices. The ROM may comprise, for example, programmable read-only memory (PROM), erasable programmable read-only memory (EPROM), electrically erasable programmable read-only memory (EEPROM), and/or other like memory devices.

The processor 18 and the memory 20 are coupled to a local interface 22. The local interface 22 can be, for example, a data bus with accompanying control bus, or a network between a processor and/or processors and/or memory or memories. Alternatively, the local interface 22 can be an appropriate network that facilitates communication between multiple processors, between a processor and a memory, or between multiple memories.

The client computer 12 has a video interface 24, a number of input interfaces 26, at least one communications interface 28, a number of output interfaces 30 and any other appropriate input/output (I/O) interface. Each interface 24, 26, 28 and 30 is coupled to the local interface 22.

The client computer 12 has a display 32 coupled to the local interface 22 via the video interface 24. Although shown as a cathode ray tube (CRT) type display, the display device may alternatively be, for example, a liquid crystal (LCD), a plasma display, an electroluminescent display, indicator lights, light emitting diodes (LEDs), or any other visual display.

The client computer 12 can include input devices such as a keyboard 34, a mouse 36 and a microphone 38. Also, the client computer 12 can include, for example, a keypad (not shown), a touch pad (not shown), a touch screen (not show), a joystick (not shown), a digital camera (not shown), a scanner (not shown), a digital pen (not shown), a data card reader (e.g., a smart card reader) (not shown), and a biometric sensor (not shown). Each input device is coupled to the local interface 22 via the input interfaces 26.

The communications interface can be, for example, a modem, network card and/or other type of transceiver. The communications interface 28 is coupled to a network 40 enabling the client computer 12 to send and receive data signals, voice signals, video signals, and the like via the network 40, as is well known in the art. The network 40 can be, for example, the Internet, an intranet, a wide area network (WAN), a local area network (LAN), direct data link, telephone network, or other similar network or communications link, including wireless networks. It is noted that the client computer 12 can be accessed and used by a remote user via the network 40 and the communications interface 28. As one skilled in the art will appreciate, multiple communication interfaces 28 can be provided. The communications interface 28 can be configured for coupling to various types of media, such as a satellite transceiver, a coaxial cable, a fiber optic cable, a telephone cable, a network cable, a wireless transceiver, or the like.

The client computer 12 can include output devices coupled via the output interfaces 30 or the network 40. Output devices include, for example, audio speakers 42, the network printers 16a-16n, a locally connected printer 44, and the like.

The server 14 can be, for example, an intranet server dedicated to providing intranet services to client devices, such as the client computer 12, connected to the network 40. In this regard, the server 14 manages network 40 usage and communications among the various devices connected to the network 40. These devices can exchange data using any of a variety of protocols, applications, hypertext links, client/server applications, and operating systems. The server 14 may also carry out other network functions such as, for example, acting as an application server, a database server, a file server, an Internet server, a mail server, a print server, a proxy server and a remote access server.

Similar to the client computer 12, the server 14 has a processor (or processors) 46 for executing instructions, usually in the form of computer code, to carry out specified logic routines. The server 14 also has a memory (or memories) 48 for storing data, software, logic routine instructions, computer programs, files, operating system instructions, and the like. Memory types similar to those described for the client computer 12 can be used for the memory or memories 48 of the server 14. The processor 46 and memory 48 of the server 14 can be coupled via a local interface 50 in a similar manner as described for the client computer 12. The local interface 50 of the server 14 is coupled to the network 40 via a network interface 52 allowing the server 14 to communicate and exchange data with other devices coupled to the network 40. Although not illustrated, the server 14 can also include a video interface, input interfaces, and output interfaces allowing the server 14 to be coupled to I/O components. These I/O components can include, for example, a display, a keyboard, a mouse, a microphone, a speaker, a printer, or other device locally coupled to the server 14. If the network 40 is an intranet, the server 14 and/or the network 40 can include a connection to another network such as a WAN or the Internet.

The memory 20 of the client computer 12 stores an operating system 54 that is executed by the processor 18 to control the allocation and usage of resources in the client computer 12. Specifically, the operating system 54 controls the allocation and usage of the memory 20, the processing time of the processor 18, and the peripheral devices, as well as performing other functionality. In this manner, the operating system 54 serves as the foundation on which applications depend, as is generally known by those with ordinary skill in the art.

The memory 20 of the client computer 12 also stores at least one application program 56 that is executed by the processor 18. The application program 56 can be, for example, a word processing program, a spreadsheet program, a drawing program, an electronic mail (“e-mail”) program or any other program from which a user may desire to print a document. More specifically, when the user desires to print from the application 56, the user can select a print command from a menu of command choices. In response to selecting the print command, the application 56 the operating system 54 and appropriate printer driver software act in conjunction to convert and transmit application 56 specific data to a selected printer. Typically, the print operation involves the use of a printer driver and/or PostScript printer description (PPD) file specific to the destination printer to convert application 56 specific data into a format compatible with the destination printer. These formats can include, for example, a page description language (PDL) file or a page control language (PCL) file.

The foregoing print operation from an application 56 being executed by the processor 18 to a printer, such as one of the network printers 16a-16n or the local printer 44, works well when the client computer 12 has installed thereon an appropriate printer driver and/or any other needed programs or files to support printing to the destination printer. However, the ability of the client computer 12 to print a document from an application 56 to a destination printer will be hampered if the client computer 12 does not have the appropriate software to support printing to the destination printer.

To assist the user in determining what printers 16a-16n and/or 44 are available for printing, the capabilities of those printers, the physical locations of those printers and/or obtaining appropriate software programs and/or files to support printing to a selected printer, a printing agent 58, a general, or “virtual”, printer driver 60 and a generic printer description file 62 (also referred to herein as a generic PPD file 62) are stored by the memory 20 and are executable by the processor 18. An example situation in which the foregoing software and an associated printer discovery operation would be useful is for a person traveling with a laptop computer who goes to a facility having the network 40 with a variety of printers 16a-16n accessible through the network 40. The person can connect their computer to become the client computer 12 and can use the printing agent 58 to seek out the printers 16a-16n available on the network 40. The printing agent 58 can also be useful when a new network printer 16 is added to the network 40. In this situation, a client computer 12, whether routinely communicating with the network 40 or infrequently communicating with the network 40, can use the printing agent 58 to find an appropriate printer driver and/or support files for the new printer added to the network 40.

The server 14 is adapted to interact with the printing agent 58 to assist in the printer discovery operation described herein. More specifically, the memory 48 of the server 14 stores an operating system 64 that is executed by the processor 48 to control the allocation and usage of resources in the server 14. Similar to the operating system 54 of the client server 12, the operating system 64 serves as a foundation on which applications executed by the processor 46 of the server 14 depend, as is generally known by those with ordinary skill in the art. The memory 48 of the server 14 also stores an agent handler 66 that, when executed by the processor 46, is used to communicate with the printing agent 58 via the network 40, as will be described in greater detail below. In addition, the memory 48 stores printer specific files 68 including printer drivers, printer specific PPD files and so forth that are transferred to the client computer 12 on an as needed basis to enable the client computer 12 to print to a selected one of the network printers 16a-16n and/or a local printer 44 connected directly to the client computer 12.

As one skilled in the art will appreciate, the printing agent 58 need only be installed once on the client computer 12. In one embodiment of the present invention, the virtual driver 60 is a PostScript printer driver since PostScript is a device independent language. The PostScript driver can use information contained in a printer specific PPD file obtained from the server 14 during a printer discovery operation to take advantage of special features of a printer selected by the user. Accordingly, the server 14 acts as a repository for printer description files (also referred to herein as PPD files) associated with each printer 16a-16n and/or 44 available to the client computer 12.

Normally, when the user invokes commands to have the application 56 print a document, the application 56 calls a printer driver to convert application specific data into a format compatible with the destination printer, or a destination printer specific format. These formats can include, for example, the PDL file format mentioned above, the PCL file format mentioned above, a graphics device interface (GDI) format that “draws” an image by sending commands that renders the image, an enhanced MetaFile (EMF) format that holds vector graphics, bit maps and text containing actual commands (i.e., GDI calls) to draw images, or some other appropriate format. The converted data is then transmitted to the printer so that the desired pattern is printed onto a print medium.

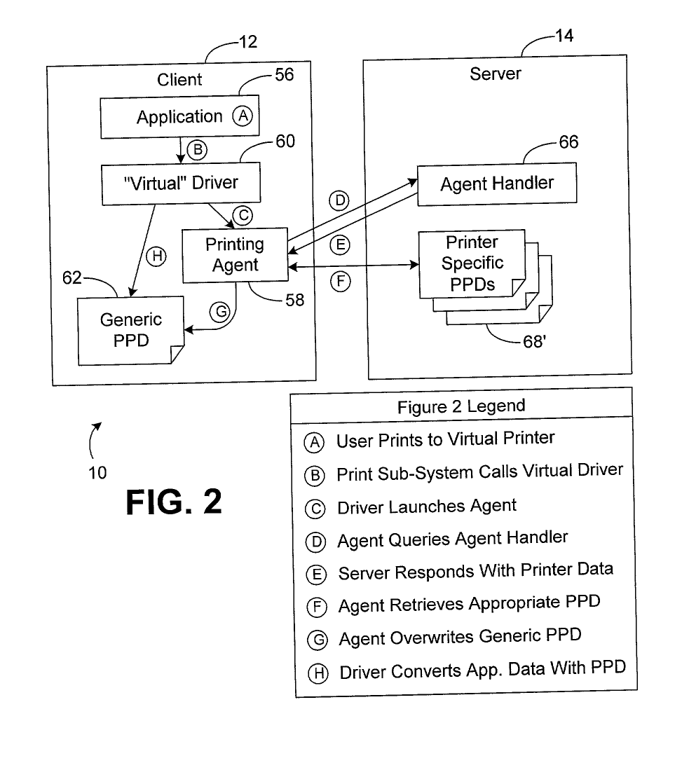

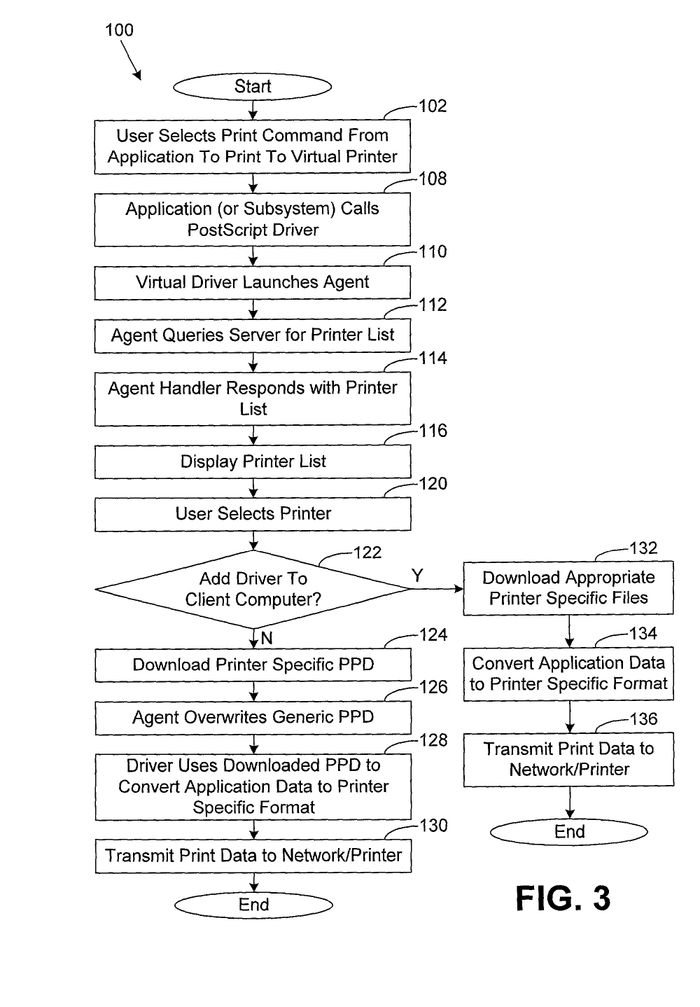

Referring now to FIG. 2, a block diagram of the computer system 10 is illustrated along with events and data transfers carried out during a printer discovery operation 100 (FIG. 3). More specifically, FIG. 2 is a block diagram illustrating events occurring within the client computer 12, events occurring within the server 14 and data transferred between the client computer 12 and the server 14 during the printer discovery operation 100 of the computer system 10. Events and data transfers illustrated in FIG. 2 are identified by circled letters A-H.

Additional reference is made to FIG. 3, where a flowchart of the printer discovery operation 100 according to an embodiment of the present invention is shown. Alternatively, the flowchart of FIG. 3 can be viewed as depicting steps in a method implemented in the computer system 10.

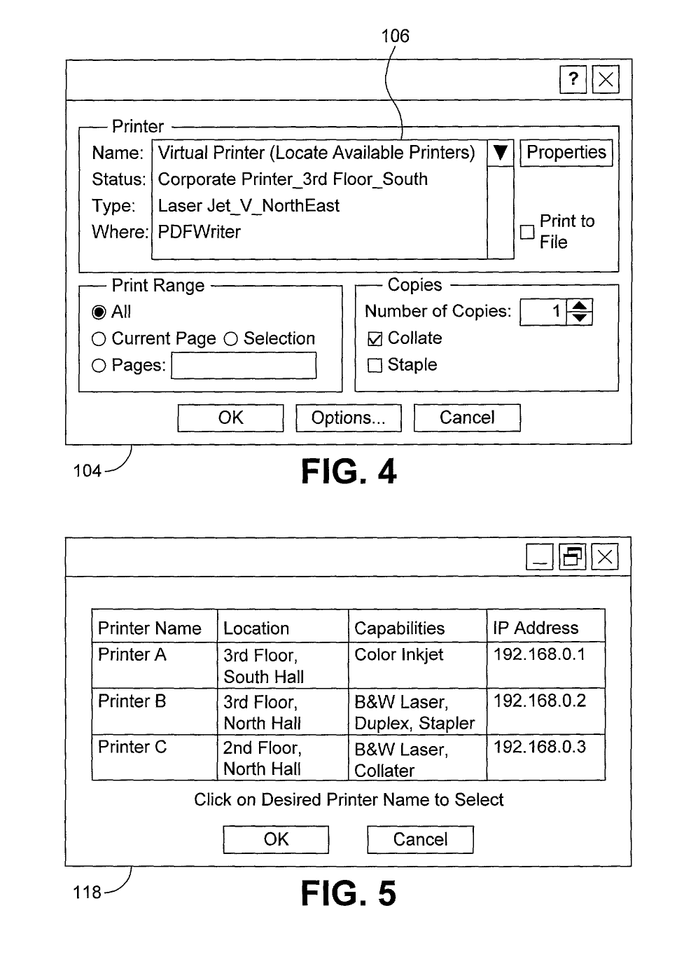

The printer discovery operation 100 starts in box 102 where the user selects a print command provided as part of the application 56 to print a document presently in a format specific to the application 56. Upon selecting the print command, the application 56 may launch a printing sub-routine, or sub-system, and the user may be presented with various options for printing the document, such as those shown in the exemplary graphical user interface (GUI) 104 of FIG. 4. Typically, the user can select one of a variety of printers (e.g., printers 16a-16n or 44) as a destination of the print job. In the GUI 104, these printers are presented to the user in a drop down menu 106. Typically, unless the user affirmatively selects a printer, documents to be printed are sent to a default printer. The default printer is a printer that the user prints to on a regular basis and has an appropriate printer driver installed on the client computer 12. In a situation where the user desires to print to a different printer and has the appropriate printer driver installed on the client computer 12, the user can change the printer selection using the menu 106.

In some situations the client computer 12 may be connected to the network 40, but the user may not have an appropriate printer driver to print to one of the network printers 16a-16n or to the local printer 44. In addition, the user may not be aware of every available printer. Should the user wish to print to a printer for which the user does not have a printer driver or if the user would like to discover available printers, the user can select a “virtual printer” selection from the menu 106.

Each printer identified on the menu 106 has a corresponding driver and/or other support software stored in the memory 20. In a typical Windows-based operating system, the user may also interact with software representing each printer via a printers folder. However, the printer driver is typically stored in a memory location separate from the printers folder. Also stored in the memory is the virtual printer driver 60 according to the present invention. The virtual printer will be available as a destination printer in the menu 106. It should be appreciated that the virtual printer choice does not represent any one particular printer, but represents the ability for the user to enter into the printer discovery operation 100 for coordinating printing to an available printer. It is noted that the selection of the print command and the virtual printer is identified as event A in FIG. 2.

Upon selecting the virtual printer from the menu 106, the application 56, or sub-system handling printing functions for the application 56, will call the virtual driver 60 in box 108. The calling of the virtual driver 60 is identified in FIG. 2 as event B. As mentioned above, the virtual driver 60 can be a generic PostScript driver, or other generic printer driver. A PostScript driver is identified since PostScript is a page description language that is used extensively on many computer platforms and is the current standard for many printers. As one skilled in the art will appreciate, PostScript commands do not drive the printer directly but are language statements in ASCII text that are translated into the destination printer's machine language by a PostScript interpreter.

Next, in box 110 and identified in FIG. 2 as event C, the virtual driver 60 launches the printing agent 58. Therefore, the virtual driver 60 is used as a means to launch the printing agent 58. This arrangement is used to bypass algorithms contained in many operating systems 54 that may preclude the launching of the printing agent 58 directly from the application 56, especially after the print command is selected. However, in an alternative embodiment of the present invention, the printing agent 58 is launched directly by the user.

Thereafter, in box 112 and identified in FIG. 2 as event D, the printing agent 56 queries the agent handler 66 for an identification of the printers available to the client computer 12. In response to the query of box 112, the agent handler 66, in box 114 and identified as Event E in FIG. 2, returns a list of available printers to the printing agent 58. This list may include network printers 16a-16n and/or the local printer 44. The list may provide an identification of the printer (e.g., a printer name), a location of the printer on the network 40 (e.g., an Internet protocol (IP) address), a physical location of the printer, and any capabilities that the printer may have (e.g., the ability to print in color, the ability to duplex or print on both sides of a sheet of print media, the ability to staple a completed print job, the ability to collate multiple copies of a print job, etc). The foregoing information regarding the available printers can be stored in a memory 48 of the server 14 in advance of receiving the query of box 112. For example, a network administrator can collect the information and populate a database stored by the memory 48 of the server 14. Alternatively, upon receiving the query of box 112, the agent handler 66 can poll devices 40 on the network for the information to assemble the list returned in box 114.

Upon receiving the printer list from the agent handler 66, the printing agent 58 displays the information related to the available printers 16 on the display 32 in box 116. With additional reference to FIG. 5, an exemplary graphical user interface (GUI) 118 for displaying the printer information is shown. The GUI 118 shows a selection of available printers by printer name, a physical location of those printers, information about the capabilities of those printers, and an IP address for each printer. It is noted that the displayed information is exemplary and can take on a number of different forms, possibly including less information or additional information regarding each printer.

Next, in box 120, the user selects one of the printers identified in the GUI 118.

In one embodiment of the invention, the printing agent 58 can be configured in box 122 to query the user as to whether the user would like the selected printer to be made an available choice of printers in the menu 106 (FIG. 4). If the user decides not to add the selected printer in the menu 106 (for example, when the user does not anticipate sending repeated print jobs to the selected printer), the printer discovery operation 100 proceeds to box 124. In box 124 and identified as event F in FIG. 2, the printing agent 58 downloads an appropriate printer specific PPD file 68′ and/or other appropriate file(s) from the server 14. Accordingly, the memory 48 of the server 14 stores a repository of PPD files 68′ for each available printer. One skilled in the art will appreciate that other types of files in addition to or instead of printer specific PPD files 68′ can be stored by the server for downloading by the client computer 12. The name of each PPD file 68′ and/or the location of each PPD file 68′ in the memory 48 of the server 14 (e.g., a file path) can be transmitted along with the printer information transmitted to the printing agent printing agent 58 in box 112 to assist the client computer 12 in downloading the appropriate printer specific file(s) 68.

Next, in box 126 and identified as event G in FIG. 2, the printing agent 58 will overwrite the generic PPD file 62 stored in the memory 20 with the printer specific PPD file 68′ downloaded from the server 14. The generic PPD file 62 functions as a placeholder for the virtual printer driver 60 so that the printer discovery operation 100 will be compatible with the functionality of most operating systems 54, which expects that each printer driver has an associated PPD file. In one embodiment of the present invention, the overwriting of the generic PPD file 62 with the downloaded PPD file 68′ is temporary until completion of subsequent steps discussed below to convert application 56 specific data for printing to printer specific data.

Next, in block 128 and as illustrated as event H in FIG. 2, the virtual printer driver 60 will use the downloaded printer specific PPD file 68′ to convert application 56 specific data into a printer specific format compatible with the selected printer. Thereafter, in box 130 a print job containing the data converted to the printer specific format is transmitted to the selected printer. If the selected printer is one of the network printers 16a-16n, the location information (e.g., the IP address) received by the client computer 12 in box 114 can be used in the assembly of data packets for transmission to the selected printer.

Returning to box 122, if the user desires to make the selected printer directly available in the menu 106 for future use, the print discovery operation 100 proceeds to box 132 where the printing agent 56 downloads a printer driver, printer specific PPD file 68′ and/or any other executable programs or files to support printing to the selected printer. Accordingly, the server 14 contains a repository of software needed to support printing to each available printer. After downloading the appropriate software and files, the software and files are installed on the client computer 12. Thereafter, the print job is handed over to the newly installed printer driver and/or PPD file for conversion to a destination printer specific format in box 134 and transmitted to the selected printer in box 136 for printing.

Although the logic used to carry out the functions of the printer discovery operation 100, including, but not limited to, the virtual printer driver 60, the printing agent 58, and the agent handler 66, of the present invention in the illustrated embodiment is embodied in software or code executed by general purpose processor hardware as discussed above, these functions can alternatively be embodied in dedicated hardware or a combination of software and hardware. If embodied in dedicated hardware, the logic can be implemented as a circuit or stay machine that employs any one of or a combination of techniques. These technologies may include, but are not limited to, discrete logic circuits having logic gates for implementing various logic functions upon an application of one or more data signals, application specific integrated circuits having appropriate logic states, programmable gate arrays (PGA), field programmable gate arrays (FPGA), or other components, etc. Such technologies are well known by those skilled in the art and, consequently, are not described in detail herein.

The figures show the architecture, functionality, and operation of an implementation of the printer discovery operation 100. If embodied in software, each illustrated block may represent a module, segment, or portion of code that comprises program logic instructions to implement the specific logical functions. The program instructions may be embodied in the form of source code that comprises human-readable statements written in a programming language or a machine code that comprises numerical instructions recognizable by a suitable execution system such as a processor in a computer system or other system. The machine code may be converted from the source code. If embodied in hardware, each block may represent a circuit or a number of interconnected circuits to implement the specified logical functions.

Although the printer discovery operation 100 illustrates a specific order of execution, it is understood that the order of execution may differ from that which is depicted. For example, the order of execution of two or more blocks may be changed relative to the order shown. Also, two or more blocks shown in succession may be executed concurrently or with partial concurrence. In addition, any number of counters, state variables, semaphores or messages can be added to the logical flow described herein for purposes of enhanced utility, accounting, performance, measurement, or providing trouble shooting aids, and the like. It is understood that all such variations are within the scope of the present invention.

Also, where the printer discovery operation 100, the virtual printer driver 60, the printing agent 58, the generic PPD file 62, and the agent handler 66 comprises software or code, these items can be embodied in any computer-readable medium for use by or in connection with an instruction execution system, such as, for example, a processor in a computer system or other system. In this sense, the logic may comprise, for example, statements including instructions or declarations that can be fetched from a computer-readable medium and executed by the instruction logic system. In the context of the present invention, a “computer-readable medium” can be any medium that can contain, store or maintain the logic described herein for use by or in connection with the instruction execution system. A computer-readable medium can comprise any one of many physical media such as, for example, electronic, magnetic, optical, electromagnetic or semiconductor media. More specific examples of suitable computer-readable medium will include, but are not limited to, magnetic tapes, magnetic floppy diskettes, magnetic hard drives, or compact disks. Also, the computer-readable medium can be random access memory (RAM), including, for example, static random access memory (SRAM), and dynamic random access memory (DRAM), or magnetic random access memory (MRAM). In addition, the computer-readable medium can be read-only memory (ROM), a programmable read-only memory (PROM), an erasable programmable read-only memory (EPROM), an electrically erasable programmable read-only memory (EEPROM) or other type of memory device.

Although particular embodiments of the invention have been described in detail, it is understood that the invention is not limited correspondingly in scope, but includes all changes, modifications and equivalents coming within the spirit and terms of the claims appended hereto.

What is claimed is:

1. A method of determining information regarding at least one printer available to receive a print job from a client computer, comprising:
transmitting a query from the client computer to a server via a network for an identification of the at least one available printer;
receiving an identification of the at least one available printer from the server; and
downloading a file from the server used to support printing to a selected one of the at least one available printer.

2. The method according to claim 1, further comprising:
calling a general printer driver from an application being executed by the client computer; and
launching a printing agent with the general printer driver, the printing agent generating the query transmitted from the client computer to the server for the identification of the at least one available printer.

3. The method according to claim 2, wherein the general printer driver is a PostScript printer driver.

4. The method according to claim 1, wherein the downloaded file is a printer description file and the method further comprises overwriting a generic printer description file with the downloaded printer description file and converting application specific data to be printed to printer specific data using the downloaded printer description file.

5. The method according to claim 4, wherein the generic printer description file is temporarily overwritten until completion of the conversion.

6. The method according to claim 1, wherein the identification of the at least one available printer received from the server is a list of printers.

7. The method according to claim 6, wherein the list of printers includes information from one or more of a physical location, a printer capability and a network address.

8. The method according to claim 1, further comprising displaying the identification of the at least one available printer for the user to select the selected one of the at least one available printer.

9. A client computer adapted for communication with a network, the network having a server and at least one printer, the client computer having a utility for determining information regarding the at least one printer comprising:
means for transmitting a query to the server via a network for an identification of the at least one available printer;
means for receiving an identification of the at least one available printer from the server; and
means for downloading a file from the server used to support printing to a selected one of the at least one available printer.

10. The client computer according to claim 9, further comprising:
means for calling a general printer driver from an application being executed by the client computer; and
means for launching a printing agent with the general printer driver, the printing agent generating the query transmitted to the server for the identification of the at least one available printer.

11. The client computer according to claim 9, wherein the downloaded file is a printer description file and the client computer further includes means for overwriting a generic printer description file with the downloaded printer description file and means for converting application specific data to be printed to printer specific data using the downloaded printer description file.

12. The client computer according to claim 11, wherein the generic printer description file is temporarily overwritten until completion of the conversion.

13. The client computer according to claim 9, wherein the identification of the at least one available printer received from the server is a list of printers including information from one or more of a physical location, a printer capability and a network address.

14. The client computer according to claim 9, further comprising means for displaying the identification of the at least one available printer for the user to select the selected one of the at least one available printer.

15. A program embodied in computer readable medium to determine information regarding at least one printer available to receive a print job from a client computer, comprising:
code that transmits a query from the client computer to a server via a network for an identification of the at least one available printer;
code that receives an identification of the at least one available printer from the server; and
code that downloads a file from the server used to support printing to a selected one of the at least one available printer.

16. The program according to claim 15, wherein the program is launched by a general printer driver, the general printer driver called from an application being executed by the client computer in response to a print command entered by a user.

17. The program according to claim 16, wherein the general printer driver is a PostScript printer driver.

18. The program according to claim 15, wherein the downloaded file is a printer description file and the program further comprises code that overwrites a generic printer description file with the downloaded printer description file so that a printer driver can convert application specific data to be printed to printer specific data using the downloaded printer description file.

19. The program according to claim 18, wherein the generic printer description file is temporarily overwritten until completion of the conversion.

20. The program according to claim 15, wherein the identification of the at least one available printer received from the server is a list of printers.

21. The program according to claim 20, wherein the list of printers includes information from one or more of a physical location, a printer capability and a network address.

22. The program according to claim 15, further comprising code that displays the identification of the at least one available printer for the user to select the selected one of the at least one available printer.

23. A program embodied in computer readable medium for execution by a server to enable a client computer to determine information regarding at least one printer available to receive a print job from the client computer, comprising:
code that receives a query from the client computer via a network for an identification of the at least one available printer;
code that transmits an identification of the at least one available printer to the client computer; and
code that transmits a file to the client computer, the file used to support printing to a selected one of the at least one available printer.

24. The program according to claim 23, wherein the downloaded file is a printer description file.

25. The program according to claim 23, wherein the identification of the at least one available printer is a list of printers.

26. The program according to claim 25, wherein the list of printers includes information from one or more of a physical location, a printer capability and a network address.

27. The program according to claim 23, further comprising code that polls network devices to determine the identification of the at least one available printer.
